(19) United States
(12) Patent Application Publication
(10) Pub. No.: US 2026/0350555 A1
(43) Pub. Date: Nov. 5, 2026

(54) Single Material Shoe Recycling System And Method

(71) Applicant: CCILU INTERNATIONAL INC., Taipei City (TW)

(72) Inventors: CHIA-MING HSU, Taipei City (TW); SHAO-WEI JEN, Taichung City (TW); Chen-En Kao, Taipei City (TW)

(21) Appl. No.: 19/663,300

(22) Filed: Apr. 30, 2026

(30) Foreign Application Priority Data
Apr. 30, 2025 (TW) 114116366

(51) Int. Cl. G06Q 10/30; A47L 23/02; B29B 17/00; B29L 31/50

(52) U.S. Cl. CPC G06Q 10/30; A47L 23/02; B29B 17/00; B29B 2017/0015; B29L 2031/50

(57) ABSTRACT

A single material shoe recycling system and method are provided. The single material shoe recycling method is applicable to the single material shoe recycling system. The single material shoe recycling system includes a shoe washing machine. The shoe washing machine includes a processing circuit, a scanning circuit coupled to the processing circuit, and a storage circuit coupled to the processing circuit. The single material shoe recycling method includes: scanning, by the identification circuit, a tag on a pair of shoes to retrieve shoe parameters for that pair of shoes stored in the storage circuit; determining, by the processing circuit, that the pair of shoes needs to be recycled when the processing circuit determines that a number of washes in the shoe parameters is greater than or equal to a recycling threshold. In this way, efficient recycling and regeneration of shoe products can be achieved, striking a balance between commercial value and environmental benefits.

### CROSS-REFERENCE TO RELATED APPLICATION

This application claims the benefit of Taiwan Application No. 114116366, filed on Apr. 30, 2025. The entire contents of the above-identified patent application are incorporated herein by reference.

### FIELD OF THE INVENTION

The present invention relates to a shoe recycling technology, specifically a single material shoe recycling system and method.

### BACKGROUND OF THE INVENTION

With growing environmental awareness, many single-use products are being phased out to prevent the waste and depletion of finite resources—a trend that is irreversible. The benefits of the circular economy, such as reuse, waste reduction, and minimization of waste, have become shared goals across all global industries, achieved through materials, manufacturing, and recycling. However, effectively implementing the principles of the circular economy in footwear products remains a key challenge in this technical field.

### SUMMARY OF THE INVENTION

The present invention provides a single material shoe recycling system and method that effectively applies the principles of the circular economy to footwear products.

To achieve one, some, or all of the above objectives, or other objectives, an embodiment of the present invention provides a single material shoe recycling system, including a shoe washing machine. The shoe washing machine includes a processing circuit, a scanning circuit coupled to the processing circuit, and a storage circuit coupled to the processing circuit. The scanning circuit scans a tag on a pair of shoes to retrieve shoe parameters for that pair of shoes stored in the storage circuit. The processing circuit determines that the pair of shoes needs to be recycled when the processing circuit determines that a number of washes in the shoe parameters is greater than or equal to a recycling threshold.

In one embodiment of the present invention, the aforementioned single material shoe recycling system further includes a cloud server. The cloud server is coupled to the shoe washing machine. The shoe washing machine further includes a communication circuit. The communication circuit is coupled to the processing circuit. The shoe washing machine synchronizes the shoe parameters of the pair of shoes to the cloud server via the communication circuit, and the cloud server initiates a recycling process for the pair of shoes based on the shoe parameters.

To achieve one, some, or all of the above objectives, or other objectives, an embodiment of the present invention provides a single material shoe recycling method applicable to the single material shoe recycling system. The single material shoe recycling method includes: scanning, by the identification circuit, a tag on a pair of shoes to retrieve shoe parameters for that pair of shoes stored in the storage circuit; determining, by the processing circuit, that the pair of shoes needs to be recycled when the processing circuit determines that a number of washes in the shoe parameters is greater than or equal to a recycling threshold.

In one embodiment of the present invention, the aforementioned single material shoe recycling method further includes: synchronizing, by the shoe washing machine, the shoe parameters of the pair of shoes to the cloud server via the communication circuit; initiating, by the cloud server, a recycling process for the pair of shoes based on the shoe parameters.

In one embodiment of the present invention, the tag is a barcode tag or an RFID tag.

In one embodiment of the present invention, the shoe parameters further include usage history and return status.

In one embodiment of the present invention, the pair of shoes includes polyolefin or polyester compounds.

By utilizing shoes made from a single recyclable material and incorporating the number of washes as a criterion for recycling and reuse, the present invention enables the effective recycling of footwear products, thereby putting the principles of the circular economy into practice in the footwear industry.

To make the above and other objectives, features, and advantages of the present invention more clearly understandable, examples are provided below and described in detail with reference to the accompanying drawings.

### BRIEF DESCRIPTION OF THE DRAWINGS

FIG. 1 is a schematic diagram of a single material shoe recycling system provided by an embodiment of the present invention.

FIG. 2 is a flowchart of a single material shoe recycling method provided by an embodiment of the present invention.

FIG. 3 is a schematic diagram of a single material shoe recycling system provided by another embodiment of the present invention.

FIG. 4 is a flowchart of a single material shoe recycling method provided by another embodiment of the present invention.

### DETAILED DESCRIPTION OF PREFERRED EMBODIMENTS

The present invention is described below with reference to the following examples, which are provided merely by way of illustration. Those skilled in the art will recognize that various modifications and improvements may be made without departing from the spirit and scope of the present disclosure; therefore, the scope of protection of the present disclosure shall be defined by the appended claims. Throughout the specification and claims, unless the context clearly indicates otherwise, the terms “a” and “the” are to be understood to include “one or at least one” element or component. Furthermore, as used herein, unless the specific context clearly excludes the plural, the singular article also includes descriptions of multiple elements or components. Moreover, when used in this description and in all of the following claims, unless the context clearly specifies otherwise, the term “in which” may include “in which” and “on which.” The terms used throughout the specification and claims, unless otherwise noted, generally have the ordinary meanings given to each term in the art, in the context of this disclosure, and in the specific context of the present invention. Certain terms used to describe the invention will be discussed below or elsewhere in this specification to provide additional guidance to those skilled in the art regarding the description of the invention. Examples appearing anywhere in the specification, including the use of any terms discussed herein, are provided merely by way of illustration and are in no way intended to limit the scope or meaning of the invention or any of the terms used. Similarly, the invention is not limited to the various embodiments described in this specification.

Furthermore, the use of the terms “coupled” or “connected” herein encompasses any means of direct or indirect electrical connection. For example, if the text describes the first device as being electrically coupled to the second device, this means that the first device may be directly connected to the second device, or indirectly connected to the second device via other devices or connection means. Furthermore, when describing the transmission or provision of electrical signals, those skilled in the art should understand that attenuation or other non-ideal changes may occur during the transmission process; however, unless otherwise specified, the source and receiving end of the transmitted or provided electrical signal should be considered to be the same signal. For example, if an electrical signal S is transmitted (or provided) from terminal A of an electronic circuit to terminal B of the same circuit, a voltage drop may occur across the source-drain terminals of a transistor switch and/or due to stray capacitance; however, unless the design is specifically intended to utilize the attenuation or other non-ideal variations generated during transmission (or provision) to achieve certain specific technical effects, the electrical signal S at terminal A and terminal B of the electronic circuit should be regarded as essentially the same signal.

It should be understood that terms such as “comprising,” “including,” “having,” “containing,” and “involving,” as used herein, are open-ended, meaning that they include but are not limited to. Furthermore, any embodiment or claim of the present invention need not achieve all of the objectives, advantages, or features disclosed herein. Additionally, the abstract and title are intended solely to assist in patent document searches and are not intended to limit the scope of the claims of the present invention.

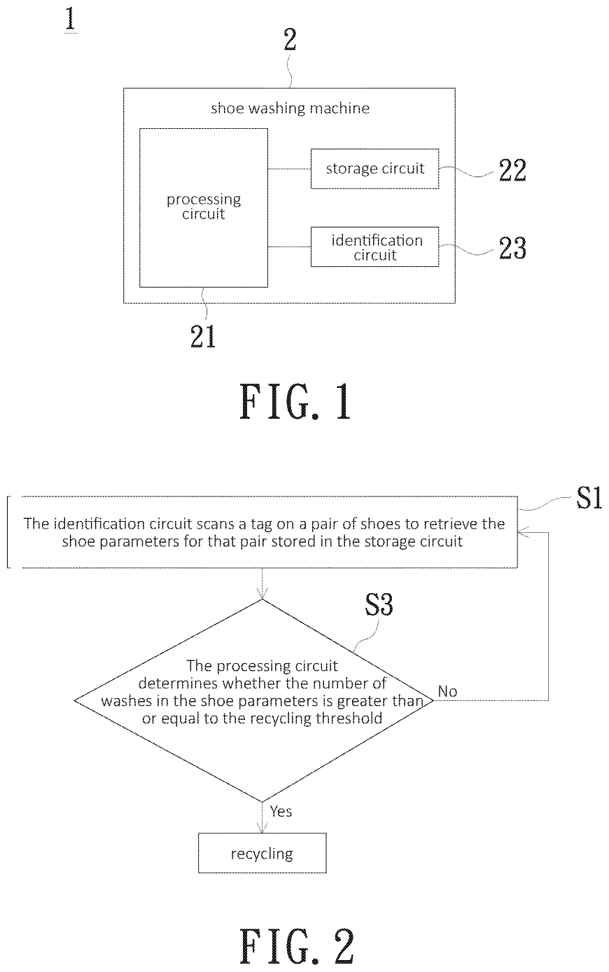

Referring to FIG. 1, a schematic diagram of a single material shoe recycling system provided by an embodiment of the present invention is shown. The single material shoe recycling system 1 provided by this embodiment includes a shoe washing machine 2. The shoe washing machine 2 includes a processing circuit 21, a storage circuit 22, and an identification circuit 23, wherein the storage circuit 22 is coupled to the processing circuit 21, and the identification circuit 23 is coupled to the processing circuit 21. The storage circuit 22 is used to store the shoe parameters for each pair of shoes. The identification circuit 23 is used to scan a label on a pair of shoes to retrieve the shoe parameters for that pair of shoes stored in the storage circuit 22. When the processing circuit 21 determines that the number of washes in the shoe parameters is greater than or equal to the recycling threshold, the processing circuit 21 determines that the pair of shoes needs to be recycled. The identification circuit 23 may be a scanning circuit for scanning a barcode label printed on the upper of the pair of shoes, or may be an RFID circuit for sensing an RFID tag embedded within the pair of shoes. It should be noted that the pair of shoes is made of a single material, such as polyolefin or polyester compounds, to ensure high durability, lightweight construction, and 100% recyclability. This facilitates post-recycling processes such as crushing, cleaning, and melting to produce high-purity material pellets, thereby achieving efficient regeneration of the shoe product. In addition to the number of washes, the shoe parameters of this pair of shoes also include the usage history and recycling status of the shoes. The usage history may include data such as rental and repair records, while the recycling status may be represented by binary bits, where bit 00 indicates not yet recycled, bit 01 indicates pending recycling, bit 11 indicates recycled, and bit 10 indicates crushed. However, the shoe parameters may also include other parameters or be represented by other digital bits; the present invention is not limited thereto. Additionally, in this embodiment, the recycling threshold may be set to 90 wash cycles, but the present invention is not limited thereto.

Refer to FIG. 2, which is a flowchart of a single material shoe recycling method provided by an embodiment of the present invention. The single material shoe recycling method provided by this embodiment is performed by the single material shoe recycling system 1 and includes the following steps. Step S1: The identification circuit 23 scans a tag on a pair of shoes to retrieve the shoe parameters for that pair stored in the storage circuit 22. Step S3: The processing circuit 21 determines whether the number of washes in the shoe parameters is greater than or equal to the recycling threshold. If the determination is yes, the processing circuit 21 determines that the pair of shoes needs to be recycled. If the determination is no, the process returns to step S1. In one example, assume a hotel rents 90 pairs of single material shoes. After a pair of shoes has been used, housekeeping staff can collect the pair and place it in the shoe washing machine 2 for cleaning. Before, after, or during the washing process in the shoe washing machine 2, the processing circuit 21 can scan the shoe's label via identification circuit 23 to retrieve all shoe parameters stored in storage circuit 22 regarding that pair of shoes. Simultaneously, the processing circuit 21 increments the number of washes by 1 and stores all shoe parameters regarding that pair back into the storage circuit 22, and the processing circuit 21 determines whether the number of washes is greater than or equal to the recycling threshold. When the processing circuit 21 determines that the number of washes for the pair of shoes is greater than or equal to the recycling threshold, housekeeping staff may retain the pair of shoes and await the subsequent recycling process. When the processing circuit 21 determines that the number of washes for the pair of shoes is less than the recycling threshold, housekeeping staff may continue to use the pair of shoes.

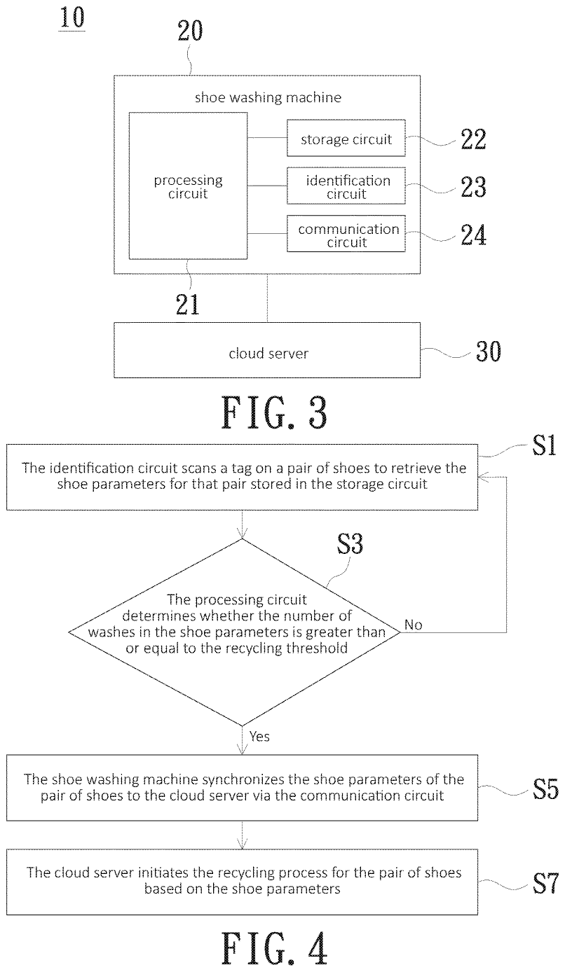

Referring to FIG. 3, a schematic diagram of a single material shoe recycling system provided by another embodiment of the present invention is shown. The single material shoe recycling system 10 provided by this embodiment includes a shoe washing machine 20 and a cloud server 30, wherein the cloud server 30 is coupled to the shoe washing machine 20. The shoe washing machine 20 includes a processing circuit 21, a storage circuit 22, an identification circuit 23, and a communication circuit 24. The storage circuit 22 is coupled to the processing circuit 21, the identification circuit 23 is coupled to the processing circuit 21, and the communication circuit 24 is coupled to the processing circuit 21. It should be noted that the functions performed by the processing circuit 21, the storage circuit 22, and the identification circuit 23 have already been described in the previous embodiment and will not be repeated here. In this embodiment, the communication circuit 24 is used to synchronize all shoe parameters for every pair of shoes in the shoe washing machine 20 to the cloud server 30, and the cloud server 30 can initiate a recycling process for each pair of shoes based on all shoe parameters for that pair. In other words, when the cloud server 30 reads the shoe parameters for a specific pair of shoes (such as when the number of washes is greater than or equal to the recycling threshold, or the recycling status is set to binary 01), the shoe recycling and remanufacturing company can initiate the recycling and remanufacturing processes for that pair. This allows for the centralized collection of all shoe products, which are then processed through crushing, cleaning, and melting to produce high-purity material pellets, which are then re-injected to manufacture new footwear products and reintroduced to the market.

Please refer to FIG. 4, which is a flowchart of a single material shoe recycling method provided by another embodiment of the present invention. The single material shoe recycling method provided by this embodiment is performed by the single material shoe recycling system 10 and includes the following steps. Step S1: A tag on a pair of shoes is scanned by the identification circuit 23 to retrieve the shoe parameters for that pair stored in the storage circuit 22. Step S3: The processing circuit 21 determines whether the number of washes in the shoe parameters is greater than or equal to the recycling threshold. If the determination is yes, the process goes to step S5. If the determination is no, the process returns to step S1. Step S5: The shoe washing machine 20 synchronizes the shoe parameters of the pair of shoes to the cloud server 30 via the communication circuit 24. Step S7: The cloud server 30 initiates the recycling process for the pair of shoes based on the shoe parameters. It should be noted that Steps S1 and S3 have already been described in the previous embodiment and will not be repeated here. Additionally, it is worth noting that Step S5 may be executed at any time and is not limited to being executed after Step S3 and before Step S7.

Finally, the shoe washing machine 2, 20 provided by the present invention includes a user interface system and software designed to enable users to operate the machine and manage data related to the allocation, cleaning, and recycling of each pair of shoes. It also provides a recycling reminder function to notify users and shoe recycling and remanufacturing companies when a pair of shoes needs to be recycled. Additionally, users who purchase, lease, or subscribe to shoe products will receive recycling credits after returning a pair of shoes, which can be applied toward the cost of new shoes. Thus, the present invention not only reduces resource waste and plastic pollution, offering environmental benefits, but also provides cost savings by allowing recycling credits to offset the cost of new shoes. Furthermore, through the user interface, it enhances the management and recycling efficiency of shoe products, enabling efficient management. Consequently, it creates a comprehensive service for a circular economy.

In summary, the single material shoe recycling system and method provided by the present invention effectively recycles footwear products and puts the principles of the circular economy into practice in the footwear industry by utilizing shoes made of a single recyclable material and basing recycling and reuse on the number of times the shoes have been washed.

Although the present invention has been disclosed above by way of examples, these are not intended to limit the scope of the invention. A person skilled in the art may make minor modifications and improvements without departing from the spirit and scope of the invention; therefore, the scope of protection of the present invention shall be determined by the appended claims.

What is claimed is:

1. A single material shoe recycling method, characterized in that the method is applicable to a single material shoe recycling system, the single material shoe recycling system comprises a shoe washing machine, the shoe washing machine comprises a processing circuit, a storage circuit, and an identification circuit, and the single material shoe recycling method comprises:
scanning, by the identification circuit, a tag on a pair of shoes to retrieve shoe parameters for that pair of shoes stored in the storage circuit;
determining, by the processing circuit, that the pair of shoes needs to be recycled when the processing circuit determines that a number of washes in the shoe parameters is greater than or equal to a recycling threshold.

2. The single material shoe recycling method according to claim 1, characterized in that the single material shoe recycling system further comprises a cloud server, the cloud server is coupled to the shoe washing machine, the shoe washing machine further comprises a communication circuit, the communication circuit is coupled to the processing circuit, and the single material shoe recycling method further comprises:
synchronizing, by the shoe washing machine, the shoe parameters of the pair of shoes to the cloud server via the communication circuit;
initiating, by the cloud server, a recycling process for the pair of shoes based on the shoe parameters.

3. The single material shoe recycling method according to claim 1, characterized in that the tag is a barcode label or an RFID tag.

4. The single material shoe recycling method according to claim 1, characterized in that the shoe parameters further comprise a usage history and a recycling status.

5. The single material shoe recycling method according to claim 1, characterized in that the pair of shoes comprises polyolefin or polyester compounds.

6. A single material shoe recycling system, characterized in that the single material shoe recycling system comprises:
a shoe washing machine, comprising:
a processing circuit;
a scanning circuit, coupled to the processing circuit; and
a storage circuit, coupled to the processing circuit;
wherein the scanning circuit scans a tag on a pair of shoes to retrieve shoe parameters for that pair of shoes stored in the storage circuit;
wherein the processing circuit determines that the pair of shoes needs to be recycled when the processing circuit determines that a number of washes in the shoe parameters is greater than or equal to a recycling threshold.

7. The single material shoe recycling system according to claim 6, characterized in that the single material shoe recycling system further comprises a cloud server, the cloud server is coupled to the shoe washing machine, the shoe washing machine further comprises a communication circuit, the communication circuit is coupled to the processing circuit, and the shoe washing machine synchronizes the shoe parameters of the pair of shoes to the cloud server via the communication circuit, and the cloud server initiates a recycling process for the pair of shoes based on the shoe parameters.

8. The single material shoe recycling system according to claim 6, characterized in that the tag is a barcode label or an RFID tag.

9. The single material shoe recycling system according to claim 6, characterized in that the shoe parameters further comprise a usage history and a recycling status.

10. The single material shoe recycling system according to claim 6, characterized in that the pair of shoes comprises polyolefin or polyester compounds.
